(19) United States
(12) Patent Application Publication
(10) Pub. No.: US 2025/0253770 A1
(43) Pub. Date: Aug. 7, 2025

(54) FLYING CAPACITOR VOLTAGE AND INDUCTOR CURRENT COMPENSATION FOR NONLINEAR COUPLING IN A THREE-LEVEL CONVERTER

(71) Applicant: Cirrus Logic International Semiconductor Ltd., Edinburgh (GB)

(72) Inventors: Jason W. LAWRENCE, Austin, TX (US); Graeme G. MACKAY, Austin, TX (US); Hasnain AKRAM, Austin, TX (US); Ilija JERGOVIC, Austin, TX (US)

(73) Assignee: Cirrus Logic International Semiconductor Ltd., Edinburgh (GB)

(21) Appl. No.: 18/618,226

(22) Filed: Mar. 27, 2024

Related U.S. Application Data
(60) Provisional application No. 63/548,677, filed on Feb. 1, 2024.
(60) Provisional application No. 63/548,684, filed on Feb. 1, 2024.

(51) Int. Cl. H02M 3/06; H02M 1/00

(52) U.S. Cl. CPC H02M 3/06; H02M 1/0009

(57) ABSTRACT

A system may include a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter. The system may also include a flying capacitor voltage control loop configured to, based on an error signal between a measurement of a flying capacitor voltage across terminals of the flying capacitor and a flying capacitor reference voltage, generate switch control signals for switching among the plurality of switch configurations in order to regulate the flying capacitor voltage and a compensator configured to apply compensation to the flying capacitor voltage control loop based on a measurement of an inductor current flowing through the power inductor.

### RELATED APPLICATION

The present disclosure claims priority to U.S. Provisional Patent Application No. 63/548,677, filed Feb. 1, 2024, and U.S. Provisional Patent Application No. 63/548,684, filed Feb. 1, 2024, both of which are incorporated by reference herein in their entireties.

### FIELD OF DISCLOSURE

The present disclosure relates in general to circuits for electronic devices, including without limitation personal audio devices such as wireless telephones and media players, and more specifically, closed-loop control of power converters, including multi-level power converters.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter).

To achieve power efficiency at light loads, power converters may be required to limit the magnitude of reverse current, as reverse current causes power loss and back-powers the power supply (e.g., battery). Limiting reverse current may be achieved using demagnetization or synchronous demagnetization with a zero-cross detector, with synchronous demagnetization typically achieving higher power efficiency. To also achieve power efficiency at light loads, power converters may also reduce switching frequency at low loads to reduce non-conduction loss terms.

A type of power converter known as a multi-level power converter (e.g., n-level power converter where n≥3) may have unique challenges at lighter loads. For example, multi-level converters may comprise one or more fly capacitors that need to be regulated within a defined range of voltage for considerations including operation within a safe operating area. However, at light loads, there may be insufficient current available to actively balance the one or more fly capacitors. Further, the magnetization and magnetization slopes may become shallow at multiple duty cycles using the typical continuous conduction mode sequence of the multi-level converter, such as a duty cycle of 0.5 for a 3-level converter (e.g., wherein duty cycle equals a ratio of an output voltage VOUT to an input voltage VIN for a buck mode operation of a 3-level converter). Such shallow slopes may not allow the power inductor of the power converter to demagnetize in time for the next switching pulse.

FIG. 1 illustrates selected components of an example circuit 100 for driving a load 120, as is known in the art. As shown in FIG. 1, a modulator 110 may receive one or more control parameters REF (e.g., which may be a digital signal indicative of a desired output voltage V_{OUT} to be driven to load 120, a desired current I_{L} to be driven through a power inductor of the modulator, and/or a desired flying capacitor voltage V_{FLY}), and based on such control parameter, generate switching control signals for controlling switches of an analog power stage 101, such as a power converter, for example. As an example, as shown in FIG. 1, modulator 110 may generate a pulse-width modulated (PWM) signal PWM1 and a PWM signal PWM2.

One type of power converter often used in electronic circuits is a 3-level power converter. FIG. 1 depicts analog power stage 101 as a 3-level power converter, as is known in the art. As shown in FIG. 1, analog power stage 101 may receive an input voltage V_{IN} and have an output configured to generate an output voltage VOUT based on switching signals received from modulator 110. Further, analog power stage 101 may include a switching node having a voltage L_{X}. Analog power stage 101 may include a power inductor 102 coupled between the switching node and the output. Moreover, analog power stage 101 may include a flying capacitor 104 having a first capacitor terminal and a second capacitor terminal, and having flying voltage V_{FLY} across its terminals. In addition, analog power stage 101 may include a plurality of switches 106a, 106b, 106c, and 106d, wherein switch 106a is coupled between the input and the first capacitor terminal, switch 106b is coupled between the first capacitor terminal and the switching node, switch 106c is coupled between the second capacitor terminal and the switching node, and switch 106d is coupled between the second capacitor terminal and a ground voltage. In operation, switches 106a, 106b, 106c, and 106d may be controlled by modulator 110 to regulate output voltage V_{OUT} to a desired target voltage. For example, PWM signal PWM1 may control switches 106b and 106c such that switch 106b is activated and switch 106c is deactivated when PWM signal PWM1 is asserted and switch 106b is deactivated and switch 106c is activated when PWM signal PWM1 is deasserted. Likewise, PWM signal PWM2 may control switches 106a and 106d such that switch 106a is activated and switch 106d is deactivated when PWM signal PWM2 is asserted and switch 106a is deactivated and switch 106d is activated when PWM signal PWM2 is deasserted.

In operation, switches 106 may be controlled to regulate output voltage V_{OUT} to a desired target voltage. As shown in FIGS. 2A and 2B, buck operation of analog power stage 101 may include cyclic, periodic commutation of switches 106 among a first state (φ1), a second state (φ2), a third state (φ3), and a fourth state (φ4). As shown in FIG. 2A, for duty cycles D of less than 0.5, switches 106a and 106c may be activated (and switches 106b and 106d deactivated) during the first state (φ1) in a VCS configuration, switches 106c and 106d may be activated (and switches 106a and 106b may be deactivated) during the second state (φ2) in a GS configuration, switches 106b and 106d may be activated (and switches 106a and 106c may be deactivated) during the third state (φ3) in a GCS configuration, and switches 106c and 106d may be activated (and switches 106a and 106b may be deactivated) during the fourth state (4) in the GS configuration.

Further, as shown in FIG. 2B, for duty cycles D of greater than 0.5, switches 106a and 106b may be activated (and switches 106c and 106d deactivated) during the first state (φ1) in a VS configuration, switches 106a and 106c may be activated (and switches 106b and 106d may be deactivated) during the second state (φ2) in the VCS configuration, switches 106a and 106b may be activated (and switches 106c and 106d may be deactivated) during the third state (φ3) in the VS configuration, and switches 106b and 106d may be activated (and switches 106a and 106c may be deactivated) during the fourth state (φ4) in the GCS configuration.

The acronyms VS, VCS, GS, and GCS stand for the path of current in each of the respective configurations, wherein “V” stands for the voltage supply, “C” stands for flying capacitor 104, “S” stands for the switching node, and “G” stands for ground voltage.

Multi-level converters such as those depicted in FIGS. 1, 2A, and 2B may have a dedicated balancing loop (not shown) for flying capacitor 104 that uses a current flowing to load 120 to regulate flying voltage V_{FLY} and a dedicated control loop (not shown) for controlling current I_{L}. In many existing control topologies, control of flying voltage V_{FLY} and control of current I_{L} are assumed to be decoupled and independent due to the presence of modulator 110. However, such assumption may only be proper when a small ripple 5 exists within current I_{L} and flying voltage V_{FLY} and when only small signal perturbations exist within current I_{L} and flying voltage V_{FLY}. On the other hand, in the presence of high-bandwidth signals or large signals, nonlinear coupling may occur between current I_{L} and flying voltage V_{FLY} that may degrade performance of system 100. Accordingly, systems and methods for minimizing or eliminating the effects of such nonlinear coupling may be desired.

### SUMMARY

In accordance with the teachings of the present disclosure, one or more disadvantages and problems associated with operation of multi-level converters at low load conditions may be reduced or eliminated.

In accordance with embodiments of the present disclosure, a system may include a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter. The system may also include a flying capacitor voltage control loop configured to, based on an error signal between a measurement of a flying capacitor voltage across terminals of the flying capacitor and a flying capacitor reference voltage, generate switch control signals for switching among the plurality of switch configurations in order to regulate the flying capacitor voltage and a compensator configured to apply compensation to the flying capacitor voltage control loop based on a measurement of an inductor current flowing through the power inductor.

In accordance with these and other embodiments of the present disclosure, a system may include a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter. The system may also include a power inductor current control loop configured to, based on an error signal between a measurement of an inductor current flowing through the power inductor and a reference inductor current, generate switch control signals for switching among the plurality of switch configurations in order to regulate the inductor current and a compensator configured to apply compensation to the power inductor current control loop based on a measurement of a flying capacitor voltage across terminals of the flying capacitor.

In accordance with these and other embodiments of the present disclosure, a system may include a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter, the switch configurations comprising at least a first switch configuration and a second switch configuration. The system may also include a flying capacitor voltage control loop configured to, in order to regulate the flying capacitor voltage, sequentially and periodically apply the first switch configuration and the second switch configuration, such that an inductor current of the power inductor flows through the flying capacitor in a first direction during the first switch configuration and flows through the flying capacitor in a second direction during the second switch configuration, and dynamically modify relative durations of the first switch configuration and the second switch configuration based on the inductor current.

In accordance with these and other embodiments of the present disclosure, a method may be provided for a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter. The method may include generating, based on an error signal between a measurement of a flying capacitor voltage across terminals of the flying capacitor and a flying capacitor reference voltage, switch control signals for switching among the plurality of switch configurations in order to regulate the flying capacitor voltage. The method may also include applying compensation to the flying capacitor voltage control loop based on a measurement of an inductor current flowing through the power inductor.

In accordance with these and other embodiments of the present disclosure, a method may be provided for a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter. The method may include, based on an error signal between a measurement of an inductor current flowing through the power inductor and a reference inductor current, generating switch control signals for switching among the plurality of switch configurations in order to regulate the inductor current. The method may also include applying compensation to the power inductor current control loop based on a measurement of a flying capacitor voltage across terminals of the flying capacitor.

In accordance with these and other embodiments of the present disclosure, a method may be provided for a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter. The method may include, in order to regulate the flying capacitor voltage, sequentially and periodically applying the first switch configuration and the second switch configuration, such that an inductor current of the power inductor flows through the flying capacitor in a first direction during the first switch configuration and flows through the flying capacitor in a second direction during the second switch configuration, and dynamically modifying relative durations of the first switch configuration and the second switch configuration based on the inductor current.

In accordance with these and other embodiments of the present disclosure, a system may include a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter. The system may also include a flying capacitor voltage control loop configured to, based on an error signal between a measurement of a flying capacitor voltage across terminals of the flying capacitor and a flying capacitor reference voltage, generate switch control signals for switching among the plurality of switch configurations in order to regulate the flying capacitor voltage and a compensator configured to apply compensation to the flying capacitor reference voltage based on a measurement of the input voltage.

In accordance with these and other embodiments of the present disclosure, a method may be provided for a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter. The method may include, based on an error signal between a measurement of a flying capacitor voltage across terminals of the flying capacitor and a flying capacitor reference voltage, generating switch control signals for switching among the plurality of switch configurations in order to regulate the flying capacitor voltage. The method may also include applying compensation to the flying capacitor reference voltage based on a measurement of the input voltage.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a circuit diagram of selected components of an example circuit for driving a load using a 3-level power converter, as is known in the art;

FIGS. 2A and 2B illustrate operation of the two-phase 3-level buck converter depicted in FIG. 1, as is known in the art;

FIG. 3 illustrates a block diagram of selected components of an example system for driving a load using a switched analog power stage, in accordance with embodiments of the present disclosure;

FIG. 4 illustrates a block diagram of selected components of an example inductor current and flying voltage controller, in accordance with embodiments of the present disclosure; and

FIGS. 5A-5C illustrate generation of reference signals REF1 and REF2, in accordance with embodiments of the present disclosure.

### DETAILED DESCRIPTION

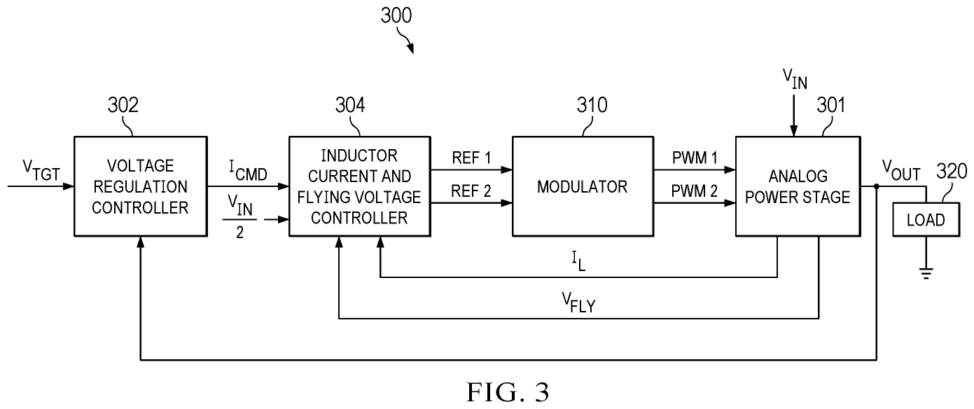

FIG. 3 illustrates a block diagram of selected components of an example system 300 for driving a load 320 using a switched analog power stage 301, in accordance with embodiments of the present disclosure. As shown in FIG. 3, system 300 may include analog power stage 301, voltage regulation controller 302, inductor current and flying voltage controller 304, modulator 310, and load 320.

Analog power stage 301 may comprise any suitable system, device, or apparatus configured to drive a power inductor current I_{L} and a voltage V_{OUT} from a supply voltage V_{IN} based on switch control signals provided from modulator 310. In some embodiments, analog power stage 301 may comprise an inductive- and/or capacitive-based power converter. In particular embodiments, analog power stage 301 may comprise a multi-level power converter identical or similar to that discussed in the Background section of this application.

Voltage regulation controller 302 may comprise any system, device, or apparatus configured to implement a control loop to regulate voltage V_{OUT} to track a target voltage VTGT. For example, based on an error between target voltage V_{TGT} and a measurement of voltage V_{OUT}, voltage regulation controller 302 may generate a commanded current I_{CMD}, which serves as a target setpoint current value for power inductor current I_{L} flowing within analog power stage 301 in order to regulate voltage V_{OUT} to target voltage VTGT.

Inductor current and flying voltage controller 304 may comprise any system, device, or apparatus configured to, based on commanded current I_{CMD} and a value equal to one half of supply voltage V_{IN}, generate two reference signals REF1 and REF2 for modulator 310.

Modulator 310 may comprise any suitable system, device, or apparatus configured to receive reference signals REF1 and REF2, and generate switching signals PWM1 and PWM2 for controlling switching of switches integral to analog power stage 301, as discussed in greater detail below. In some embodiments, modulator 310 may comprise a pulse-width modulator.

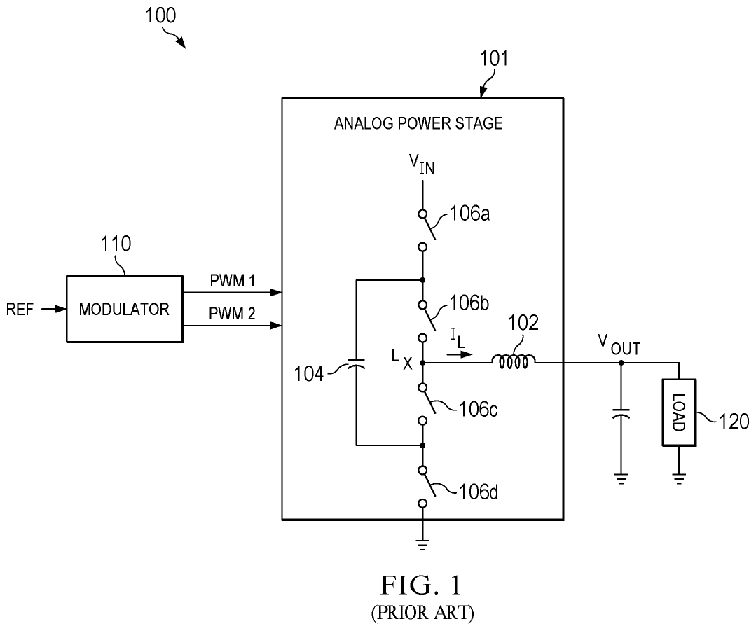

If analog power stage 301 is identical to similar analog power stage 101 of FIG. 1, and is operating in a buck mode of operation, PWM signal PWM1 may control switches 106b and 106c such that switch 106b is activated and switch 106c is deactivated when PWM signal PWM1 is asserted and switch 106b is deactivated and switch 106c is activated when PWM signal PWM1 is deasserted. Likewise, PWM signal PWM2 may control switches 106a and 106d such that switch 106a is activated and switch 106d is deactivated when PWM signal PWM2 is asserted and switch 106a is deactivated and switch 106d is activated when PWM signal PWM2 is deasserted.

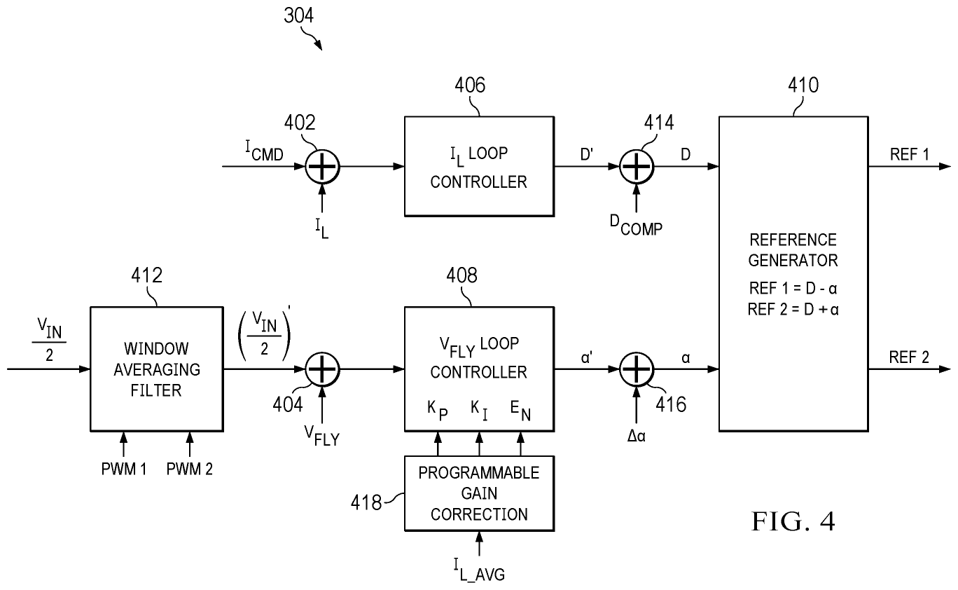

Load 320 may include any appropriate electrical or electronic load that may be powered from analog power stage 301, including without limitation a rechargeable battery. FIG. 4 illustrates a block diagram of selected components of an example inductor current and flying voltage controller 304, in accordance with embodiments of the present disclosure. As shown in FIG. 4, inductor current and flying voltage controller 304 may have an inductor current control loop for controlling power inductor current I_{L} and a flying capacitor voltage control loop for controlling flying capacitor voltage V_{FLY}. The inductor current control loop may include an error summer 402 and an I_{L} loop controller 406. Error summer 402 may generate an error signal based on the difference between commanded current I_{CMD} and power inductor current I_{L}. I_{L} loop controller 406 may generate a duty cycle signal D based on the error signal, increasing duty cycle signal D when power inductor current I_{L} is below commanded current I_{CMD} and decreasing duty cycle signal D when power inductor current I_{L} is above commanded current I_{CMD}. In some embodiments, I_{L} loop controller 406 may comprise a proportional-integral (PI) controller.

Similarly, the flying capacitor voltage control loop may include an error summer 404 and a V_{FLY} loop controller 408. Error summer 404 may generate an error signal based on the difference between the one-half of input voltage V_{IN} (e.g., V_{IN}/2) and flying voltage V_{FLY}. V_{FLY} loop controller 408 may generate an offset signal α based on the error signal, increasing offset signal α when flying capacitor voltage V_{FLY} is below commanded current V_{FLY}/2 and decreasing offset signal α when flying capacitor voltage V_{FLY} is above V_{FLY}/2. In some embodiments, V_{FLY} loop controller 408 may comprise a proportional-integral (PI) controller.

As further shown in FIG. 4, inductor current and flying voltage controller 304 may include a reference generator 410. Reference generator 410 may include any system, device, or apparatus configured to generate reference signals REF1 and REF2 from duty cycle signal D and offset signal α. For example, as shown in FIG. 4, reference signal REF1 may be defined by REF1=D−α while reference signal REF2 may be defined by REF2=D+α. So, duty cycle signal D may be thought of as an average or common mode of reference signals REF1 and REF2, while offset signal α is an offset of reference signals REF1 and REF2 from such average or common mode.

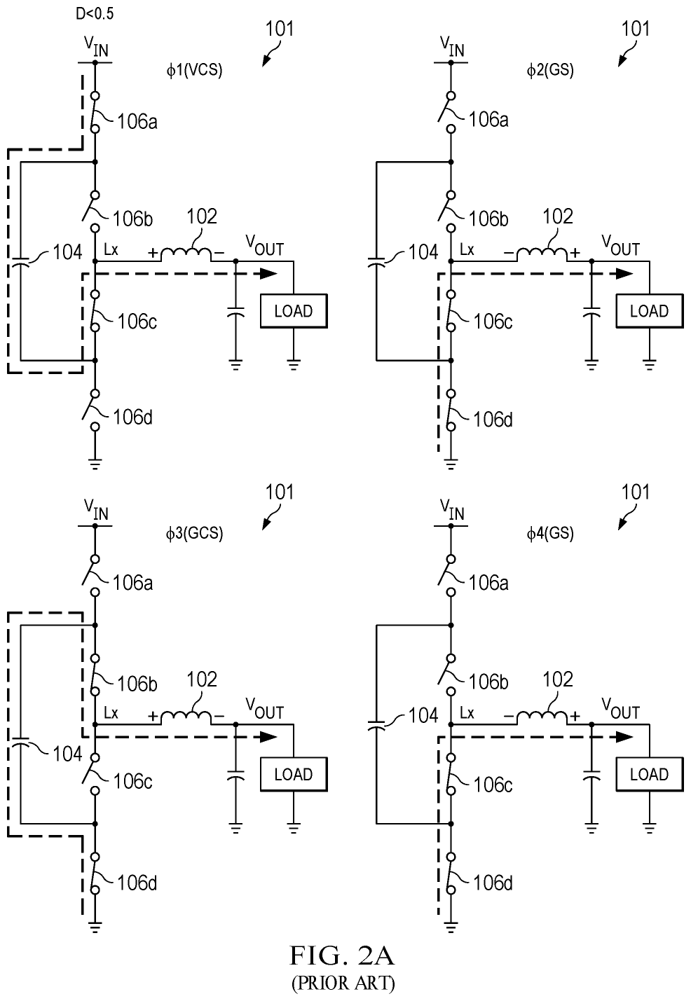

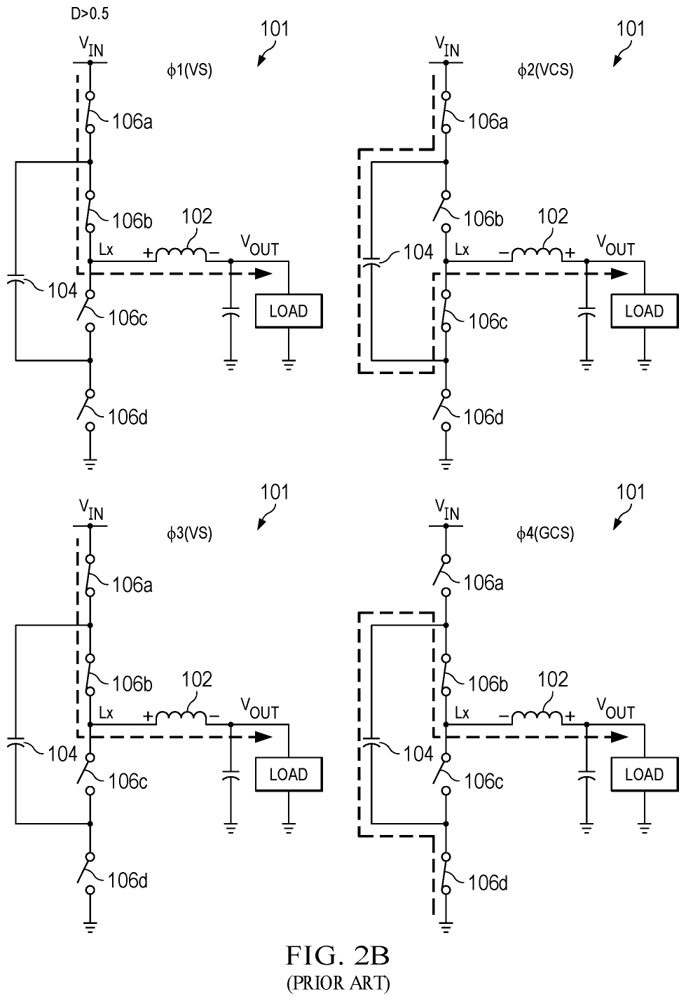

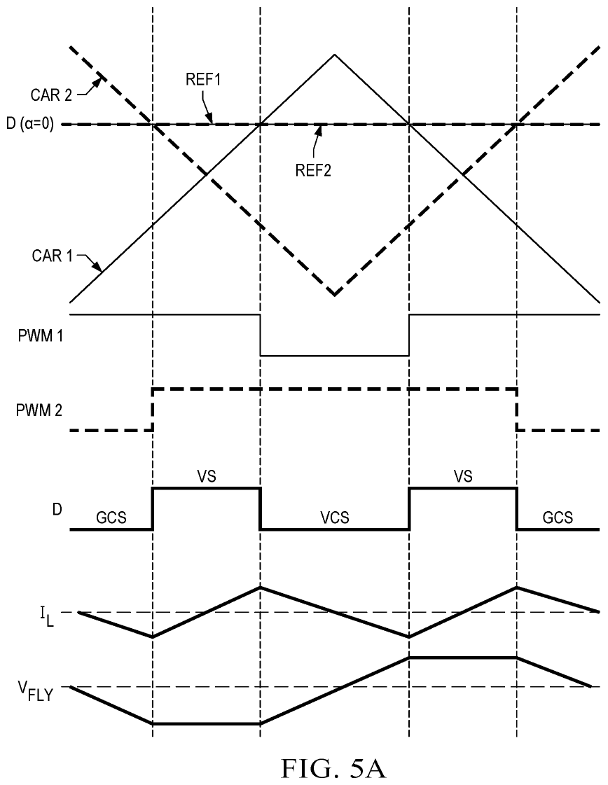

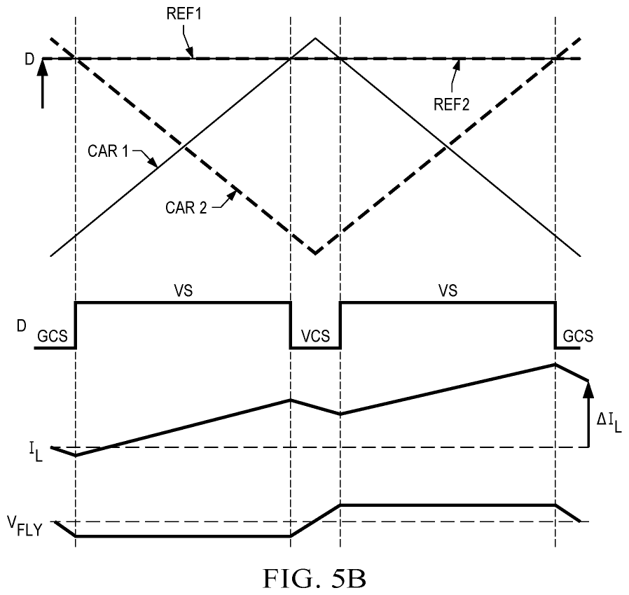

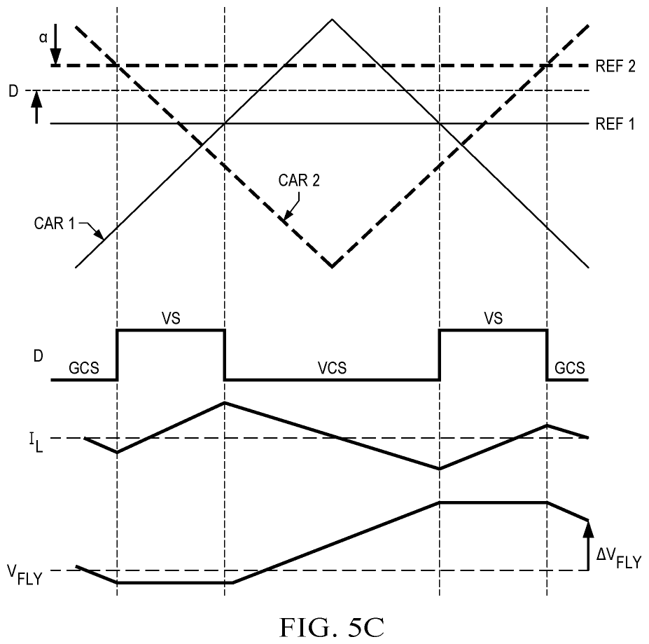

Generation of reference signals REF1 and REF2 may be further illustrated by reference to FIGS. 5A-5C. FIG. 5A depicts nominal waveforms of reference signals REF1, REF2, triangle wave carrier signals CAR1 and CAR2 of modulator 310, switching control signals PWM1 and PWM2, duty cycle D for power inductor current I_{L}, power inductor current I_{L}, and flying capacitor voltage V_{FLY}. The waveforms shown in FIG. 5A are for buck mode operation (e.g., V_{OUT}>V_{IN}/2) and for duty cycles of power inductor current I_{L} greater than 0.5 (e.g., switching sequence of FIG. 2B). However, similar concepts and techniques may apply to other modes of operation and to buck mode operation for duty cycles of power inductor current I_{L} lesser than 0.5 (e.g., switching sequence of FIG. 2A).

As shown in FIG. 5A, switching signal PWM1 may comprise a PWM signal generated by comparing reference signal REF to a first triangular carrier wave CAR1, such that switching signal PWM1 is asserted when reference signal REF1 exceeds first triangular carrier wave CAR1 and is deasserted when reference signal REF1 is less than first triangular carrier wave CAR1. Similarly, switching signal PWM2 may comprise a PWM signal generated by comparing reference signal REF2 to a second triangular carrier wave CAR2, wherein second triangular carrier wave CAR2 may be the opposite of first triangular carrier wave CAR1, such that switching signal PWM2 is asserted when reference signal REF2 exceeds second triangular carrier wave CAR2 and is deasserted when reference signal REF2 is less than second triangular carrier wave CAR2.

As shown in FIG. 5B, to increase power inductor current I_{L} by an amount ΔI_{L}, I_{L} loop controller 406 may increase duty cycle signal D, which may in turn increase reference signals REF1 and REF2, increasing the time analog power stage 301 is in the VS configuration and decreasing the time analog power stage 301 is in the VCS and GCS configurations. Similarly, to decrease power inductor current I_{L}, I_{L} loop controller 406 may decrease duty cycle signal D, which may in turn decrease reference signals REF1 and REF2, decreasing the time analog power stage 301 is in the VS configuration and increasing the time analog power stage 301 is in the VCS and GCS configurations.

As shown in FIG. 5C, to increase flying capacitor voltage V_{FLY} by an amount ΔV_{FLY}, V_{FLY} loop controller 408 may increase offset signal α, which may in turn increase reference signal REF2 while decreasing reference signal REF1, increasing the time analog power stage 301 is in the VCS configuration and decreasing the time analog power stage 301 is in the GCS configuration. Similarly, to decrease flying capacitor voltage V_{FLY}, V_{FLY} loop controller 408 may decrease offset signal α, which may in turn decrease reference signal REF2 while increasing reference signal REF1, decreasing the time analog power stage 301 is in the VCS configuration and increasing the time analog power stage 301 is in the GCS configuration.

For the purposes of clarity and exposition, the foregoing description of operation of inductor current and flying voltage controller 304 has ignored compensation terms applied to loop control, which are described in greater detail below. Such compensation terms may be required to correct for non-linear coupling between power inductor current I_{L} and flying capacitor voltage V_{FLY} that may result from high bandwidth and large signals and result in performance degradation.

Turning again to FIG. 4, one compensation for non-linearity may correct for non-linear effects to offset signal α which may result from a commanded change ΔI_{CMD} to commanded current I_{CMD}. Such correction may be performed by summer 416, which adds an alpha compensation Δα to a raw offset signal α′ generated by V_{FLY} loop controller 408, to generate a compensated offset signal α received by reference generator 410.

To illustrate calculation of alpha compensation Δα, is it noted that commanded change ΔI_{CMD} may be given by:

$$Δ {I}_{CMD} = \frac{T}{2 L} {V}_{IN} Δ D$$

where T is equal to the reciprocal of the switching frequency of analog power stage 301, L equals an inductance of a power inductor (e.g., power inductor 102) through which power inductor current I_{L} flows, and ΔD equals a change in duty cycle D for inductor current I_{L}. Given such commanded change ΔI_{CMD}, alpha compensation Δα may be calculated using the quadratic formula as:

$$Δα = \frac{- b + \sqrt{{b}^{2} - 4 a c}}{2 a}$$

wherein the values a, b, and c are given by:

$$\begin{matrix}a = ( s ) ( \frac{T ( {V}_{OUT} - \frac{{V}_{IN}}{2} )}{2 L} ) and \{ \begin{matrix}s = 1 if CAR 1 rising and CAR 2 falling \\ s = - 1 if CAR 2 rising and CAR 2 falling\end{matrix} \\ b = {I}_{CMD} + {I}_{INIT} \\ c = ( s ) [ \tilde{D} ( {I}_{CMD} - {I}_{INIT} + \frac{T ( {V}_{OUT} - \frac{{V}_{IN}}{2} )}{2 L} ) ( {\tilde{D}}^{2} - {D}_{0}^{2} ) ]\end{matrix}$$

where I_{INIT} represents the value of commanded current I_{CMD} prior to commanded change ΔI, \tilde{D}=└2D−1┘, and D₀ equals the initial value for duty cycle D prior to commanded change ΔI.

In some embodiments, to simplify the complexity of the solution of alpha compensation Δα to linear instead of a quadratic function, alpha compensation Δα may be given by:

$$Δα = \frac{- c}{b}$$

Another compensation for non-linearity may correct for non-linear effects to offset signal α that may occur for lower values of power inductor current I_{L}. For sufficiently high values of power inductor current I_{L}, the change ΔV_{FLY} in flying capacitor voltage V_{FLY} per switching cycle of analog power stage 310 may be approximated by:

$$Δ {V}_{FLY} \approx ( 2 {I}_{L \_ AVG} \frac{T}{{C}_{FLY}} ) α$$

where I_{L_AVG} is the average value of power inductor current I_{L} and CFLY is the capacitance of the flying capacitor of analog power stage 301. However, when power inductor current I_{L} is low (e.g., near zero), change ΔV_{FLY} may no longer be linearly related to offset signal α, with the nonlinearity becoming worse as power inductor current I_{L} continues to decrease.

In order to correct for this nonlinearity, inductor current and flying voltage controller 304 may include a programmable gain correction block 418 configured to control controller gains (e.g., proportional gain K_{P} and integral gain K_{I}) of V_{FLY} loop controller 408 based on average power inductor current I_{L_AVG}. In addition, programmable gain correction block 418 may also be configured to selectively enable and disable V_{FLY} loop controller 408 (e.g., such that the raw offset signal α′ generated by V_{FLY} loop controller 408 is zero during periods of time in which V_{FLY} loop controller 408 is disabled).

For example, for values of power inductor current I_{L_AVG} below a first threshold (e.g., 0.5 A), severe nonlinearities between change ΔV_{FLY} and offset signal α may be expected, and thus programmable gain correction block 418 may disable alpha control of flying capacitor voltage V_{FLY}. As another example, for values of power inductor current I_{L_AVG} above the first threshold but below a second threshold (e.g., 2.0 A), some nonlinearities between change ΔV_{FLY} and offset signal α may be expected, and thus programmable gain correction block 418 may (e.g., based on a formula or values set forth in a lookup table) set gain values of inductor current and flying voltage controller 304 (e.g., proportional gain K_{P} and integral gain K_{I}) as a function of power inductor current I_{L_AVG}. As a further example, for values of power inductor current I_{L_AVG} above the second threshold, fewer nonlinearities may be present, and thus programmable gain correction block 418 may (e.g., based on a formula or values set forth in a lookup table) set gain values of inductor current and flying voltage controller 304 (e.g., proportional gain K_{P} and integral gain K_{I}) as a function of power inductor current I_{L_AVG} to a “normal” range of gain values.

A further compensation for non-linearity may correct for non-linear effects to duty cycle signal D that may occur when flying capacitor voltage V_{FLY} is overcharged. Such correction may be performed by summer 414, which adds a duty cycle compensation D_{COMP} to a raw duty cycle signal D′ generated by I_{L} loop controller 406, to generate a compensated duty cycle signal D received by reference generator 410. Duty cycle compensation D_{COMP} may be given by:

$${D}_{COMP} = α ( \frac{2 {V}_{FLY}}{{V}_{IN}} - 1 )$$

As duty cycle signal D approaches 0 or 1, either reference signal REF1 or REF2 may saturate. In such cases, it may be desirable to preserve duty cycle signal D (including the duty cycle compensation described above) and “sacrifice” α. In other words, as duty cycle signal D approaches 0 or 1, reference generator 410 may continue to rely on duty cycle signal D to control reference signals REF1 and REF2, while fading out its reliance on offset signal α in the control of reference signals REF1 and REF2 when duty cycle signal D is within a predefined margin of 0 or 1. The following pseudocode describes an algorithm to take in account such saturation:

```
c₁ = (V_{FLY}/V_{IN});
c₂ = 1/c₁;
c₃ = 1/ (c₁ − 1);
D=D′+α*(2*c₁−2);
R1=D−α
R2=D+α
if REF1<0
  REF1_FF=0
  REF2_FF=D′*(−c₃)
else if REF2<0
  REF2_FF=0
  REF1_FF=D′*(c₂)
else if REF1>1
  REF1_FF=1
  REF2_FF=c₃*(c₁−D′)
else if REF2>1
  REF2_FF=1
  REF1_FF=c₂*(D′−1)
```

A further compensation for non-linearity may correct for non-linear effects resulting from using V_{IN}/2 as the reference signal for the flying capacitor voltage control loop when a ripple on input voltage V_{IN} is large. Such correction may be performed by window averaging filter 412, as described below. As shown in FIGS. 2A and 2B, input voltage V_{IN} may be coupled to power inductor 102 during the VS and VCS configurations. Thus, window averaging filter 412 may be configured to, based on switch control signal PWM1 and/or PWM2, average input voltage V_{IN} (or average V_{IN}/2) during a window of time in which input voltage V_{IN} is coupled to power inductor 102 and then output such windowed average as a modified reference signal (V_{IN}/2)′ to the flying capacitor voltage control loop. For example, in some embodiments, window averaging filter 412 may use switch control signal PWM1 to average during the full window in which input voltage V_{IN} may be coupled to power inductor 102 (e.g., both the VS and VCS configurations). As another example, in other embodiments, window averaging filter 412 may use both switch control signals PWM1 and PWM2 to average during the VCS configuration. In these and other embodiments, window averaging filter 412 may include delay elements that delay received switch control signals PWM1 and PWM2 to properly match any delays present in inductor current and flying voltage controller 304.

The foregoing discussion contemplates the use of four approaches to compensating for non-linearities resulting from non-linear coupling between power inductor current I_{L} and flying capacitor voltage V_{FLY}: alpha compensation in the flying capacitor voltage control loop (e.g., with summer 416 and alpha compensation α), programmable gain correction and/or selective enablement of the loop controller of the flying capacitor voltage control loop based on average power inductor current (e.g., with programmable gain correction block 418), duty cycle compensation (including saturation) in the inductor current control loop (e.g., with summer 416 and duty cycle compensation D_{COMP}), and windowed averaging of the flying capacitor voltage control loop reference signal (e.g., with window averaging filter 412). It is understood that embodiments of the present disclosure may employ any one or more of these approaches in any suitable combination.

The foregoing description contemplates operation of system 300 in the buck mode. Operation of system 300 in a boost mode may be analogous to that described above with respect to the buck mode, but wherein magnetization of the power inductor is via the GS configuration and demagnetization of the power inductor is via the VS configuration.

In some embodiments, system 300 may be embodied in a program of computer-readable instructions and executed by a processing device, including without limitation a processor, application-specific integrated circuit, digital signal processor, or any other suitable processing device.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter;
a flying capacitor voltage control loop configured to, based on an error signal between a measurement of a flying capacitor voltage across terminals of the flying capacitor and a flying capacitor reference voltage, generate switch control signals for switching among the plurality of switch configurations in order to regulate the flying capacitor voltage; and
a compensator configured to apply compensation to the flying capacitor voltage control loop based on a measurement of an inductor current flowing through the power inductor.

2. The system of claim 1, wherein the compensator is configured to apply compensation to the flying capacitor voltage control loop based on an average of the inductor current flowing through the power inductor.

3. The system of claim 1, wherein:
the flying capacitor voltage control loop comprises a loop controller configured to generate a control parameter based on the error signal and generate the switch control signals based on the control parameter; and
the compensator is configured to apply a compensation to the control parameter based on the measurement of the inductor current.

4. The system of claim 1, wherein:
the flying capacitor voltage control loop comprises a loop controller configured to generate a control parameter based on the error signal and generate the switch control signals based on the control parameter; and
the compensator is configured to apply a compensation to a gain of the loop controller based on the measurement of the inductor current.

5. The system of claim 1, wherein:
the flying capacitor voltage control loop comprises a loop controller configured to generate a control parameter based on the error signal and generate the switch control 10 signals based on the control parameter; and
the compensator is configured to selectively enable adaptation of the control parameter based on the measurement of the inductor current.

6. A system comprising:
a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter;
a power inductor current control loop configured to, based on an error signal between a measurement of an inductor current flowing through the power inductor and a reference inductor current, generate switch control signals for switching among the plurality of switch configurations in order to regulate the inductor current; and
a compensator configured to apply compensation to the power inductor current control loop based on a measurement of a flying capacitor voltage across terminals of the flying capacitor.

7. The system of claim 6, wherein:
the power inductor current control loop comprises a loop controller configured to generate a control parameter based on the error signal and generate the switch control signals based on the control parameter; and
the compensator is configured to apply a compensation to the control parameter based on the measurement of the flying capacitor voltage.

8. The system of claim 6, further comprising:
a flying capacitor voltage control loop configured to, based on a second error signal between a measurement of the flying capacitor voltage and a flying capacitor reference voltage, generate the switch control signals for switching among the plurality of switch configurations in order to regulate the flying capacitor voltage; and
the compensator is further configured to apply compensation to the flying capacitor voltage control loop based on a measurement of the inductor current.

9. The system of claim 8, wherein the compensator is further configured to, when a duty cycle of the inductor current is with a predefined margin of 0 or 1, fade out control of the switch control signals with the flying capacitor voltage control loop as the duty cycle of the inductor current approaches 0 or 1.

10. The system of claim 8, wherein the compensator is configured to apply compensation to the flying capacitor voltage control loop based on an average of the inductor current flowing through the power inductor.

11. The system of claim 8, wherein:
the flying capacitor voltage control loop comprises a loop controller configured to generate a control parameter based on the error signal and generate the switch control signals based on the control parameter; and
the compensator is configured to apply a compensation to the control parameter based on the measurement of the inductor current.

12. The system of claim 8, wherein:
the flying capacitor voltage control loop comprises a loop controller configured to generate a control parameter based on the error signal and generate the switch control signals based on the control parameter; and
the compensator is configured to apply a compensation to a gain of the loop controller based on the measurement of the inductor current.

13. The system of claim 8, wherein:
the flying capacitor voltage control loop comprises a loop controller configured to generate a control parameter based on the error signal and generate the switch control signals based on the control parameter; and
the compensator is configured to selectively enable adaptation of the control parameter based on the measurement of the inductor current.

14. A system comprising:
a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter, the switch configurations comprising at least a first switch configuration and a second switch configuration; and
a flying capacitor voltage control loop configured to, in order to regulate a flying capacitor voltage of the flying capacitor:
sequentially and periodically apply the first switch configuration and the second switch configuration, such that an inductor current of the power inductor flows through the flying capacitor in a first direction during the first switch configuration and flows through the flying capacitor in a second direction during the second switch configuration; and
dynamically modify relative durations of the first switch configuration and the second switch configuration based on the inductor current.

15. A method comprising, in a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter:
generating, based on an error signal between a measurement of a flying capacitor voltage across terminals of the flying capacitor and a flying capacitor reference voltage, switch control signals for switching among the plurality of switch configurations in order to regulate the flying capacitor voltage; and
applying compensation to a flying capacitor voltage control loop configured to control the flying capacitor voltage based on a measurement of an inductor current flowing through the power inductor.

16. The method of claim 15, further comprising applying compensation to the flying capacitor voltage control loop based on an average of the inductor current flowing through the power inductor.

17. The method of claim 15, further comprising:
generating a control parameter with a loop controller based on the error signal and generating the switch control signals based on the control parameter; and
applying a compensation to the control parameter based on the measurement of the inductor current.

18. The method of claim 15, further comprising:
generating a control parameter with a loop controller based on the error signal and generating the switch control signals based on the control parameter; and
applying a compensation to a gain of the loop controller based on the measurement of the inductor current.

19. The method of claim 15, further comprising:
generating a control parameter with a loop controller based on the error signal and generating the switch control signals based on the control parameter; and
selectively enabling adaptation of the control parameter based on the measurement of the inductor current.

20. A method comprising, in a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter:
based on an error signal between a measurement of an inductor current flowing through the power inductor and a reference inductor current, generating switch control signals for switching among the plurality of switch configurations in order to regulate the inductor current; and
applying compensation to a power inductor current control loop for controlling the inductor current based on a measurement of a flying capacitor voltage across terminals of the flying capacitor.

21. The method of claim 20, further comprising:
generating with a loop controller a control parameter based on the error signal and generating the switch control signals based on the control parameter; and
applying a compensation to the control parameter based on the measurement of the flying capacitor voltage.

22. The method of claim 20, further comprising:
based on a second error signal between a measurement of the flying capacitor voltage and a flying capacitor reference voltage, generating the switch control signals for switching among the plurality of switch configurations in order to regulate the flying capacitor voltage; and
applying compensation to a flying capacitor voltage control loop configured to control the flying capacitor voltage based on a measurement of the inductor current.

23. The method of claim 22, further comprising, when a duty cycle of the inductor current is within a predefined margin of 0 or 1, fading out control of the switch control signals with the flying capacitor voltage control loop as the duty cycle of the inductor current approaches 0 or 1.

24. The method of claim 22, further comprising applying compensation to the flying capacitor voltage control loop based on an average of the inductor current flowing through the power inductor.

25. The method of claim 22, further comprising:
generating with a loop controller a control parameter based on the error signal and generating the switch control signals based on the control parameter; and
applying a compensation to the control parameter based on the measurement of the inductor current.

26. The method of claim 22, further comprising:
generating with a loop controller a control parameter based on the error signal and generating the switch control signals based on the control parameter; and
applying a compensation to a gain of the loop controller based on the measurement of the inductor current.

27. The method of claim 22, further comprising:
generating with a loop controller a control parameter based on the error signal and generating the switch control signals based on the control parameter; and
selectively enabling adaptation of the control parameter based on the measurement of the inductor current.

28. A method comprising, in a multi-level power converter comprising a plurality of switches, a power inductor electrically coupled to the plurality of switches, and a flying capacitor coupled to the plurality of switches, wherein the plurality of switches are controllable among a plurality of switch configurations in order to generate an output voltage from an input voltage received by the multi-level power converter, the switch configurations comprising at least a first switch configuration and a second switch configuration, in order to regulate the flying capacitor voltage:
sequentially and periodically applying the first switch configuration and the second switch configuration, such that an inductor current of the power inductor flows through the flying capacitor in a first direction during the first switch configuration and flows through the flying capacitor in a second direction during the second switch configuration; and
dynamically modifying relative durations of the first switch configuration and the second switch configuration based on the inductor current.
